(19) United States
(12) Patent Application Publication
(10) Pub. No.: US 2007/0263531 A1
(43) Pub. Date: Nov. 15, 2007

(54) SYSTEM, APPARATUS FOR SWITCHING NETWORKS AND METHOD THEREFOR

(75) Inventor: Wei-Hung Huang, Hsin-chu City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Media Tek, Inc., Hsin-Chu City (TW)

(21) Appl. No.: 11/382,383

(22) Filed: May 9, 2006

(51) Int. Cl. H04J 3/14; H04L 12/26

(52) U.S. Cl. 370/225; 370/237

(57) ABSTRACT

An apparatus for switching between a first network and a second network comprises a generator, a processor and a switch. The generator generates a table, wherein the table stores first connection information for the first network and second connection information for the second network. The processor checks a status of the first network in response to the first connection information. The switch selects the second network to communicate in response to the second connection information if the status indicates that the first network is not available. A method for switching between a first network and a second network comprises: generating a table, wherein the table stores first connection information for the first network and second connection information for the second network; checking a status of the first network in response to the first connection information; and selecting the second network to communicate in response to the second connection information if the status indicates that the first network is not available.

### CROSS-REFERENCES TO RELATED APPLICATIONS

Not applicable.

### BACKGROUND OF THE INVENTION

1. Field of the Invention

The present invention relates to a system and an apparatus for switching networks, and a method therefor; more specifically, relates to a system, an apparatus and a method for switching networks automatically by checking statuses of the networks.

2. Descriptions of the Related Art

VoIP (voice over internet protocol) apparatuses have become popular communication devices in office or at home nowadays. In addition to audio packages, these apparatuses in the current market may further transmit data and/or video packages. One benefit of using the apparatuses is to reduce costs.

However, the VoIP apparatuses are not so convenient to use. One of the inconveniences is that a user has to check if a receiving person is on line. If not, the user cannot reach the receiving person through a VoIP apparatus, and needs to reach the receiving person in another way. Accordingly, a solution to solve the inconvenience is desired in the industrial field.

### SUMMARY OF THE INVENTION

One object of this invention is to provide an apparatus for switching between a first network and a second network. The apparatus comprises a generator, a processor, and a switch. The generator is configured to generate a table, wherein the table stores first connection information for the first network and second connection information for the second network. The processor is configured to check a status of the first network in response to the first connection information. The switch is configured to select the second network to communicate in response to the second connection information if the status indicates that the first network is not available.

Another object of this invention is to provide a method for switching between a first network and a second network. The method comprises the following steps: generating a table, wherein the table stores first connection information for the first network and second connection information for the second network; checking a status of the first network in response to the first connection information; and selecting the second network to communicate in response to the second connection information if the status indicates that the first network is not available.

Another object of this invention is to provide a communication system. The communication system comprises a first network, a second network, and an apparatus. The apparatus has a table that stores first connection information for the first network and second connection information for the second network. The apparatus is configured to check a status of the first network in response to the first connection information, and select the second network to communicate in response to the second connection information if the status indicates that the first network is not available.

Another object of this invention is to provide an apparatus for switching between a first network and a second network. The apparatus comprises means for generating a table, wherein the table stores first connection information for the first network and second connection information for the second network; means for checking a status of the first network in response to the first connection information; and means for selecting the second network to communicate in response to the second connection information if the status indicates that the first network is not available.

When a user wants to communicate with a person, the present invention first checks the status of one network, i.e., the first network, and then automatically switches to another network, i.e., the second network to communicate if the first network is not available. Therefore, the user may reach the person through more than one network by a single apparatus in accordance with the present invention.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram of a first embodiment of the present invention; and

FIG. 2 is a flow chart of a second embodiment of the present invention.

### DESCRIPTION OF THE PREFERRED EMBODIMENT

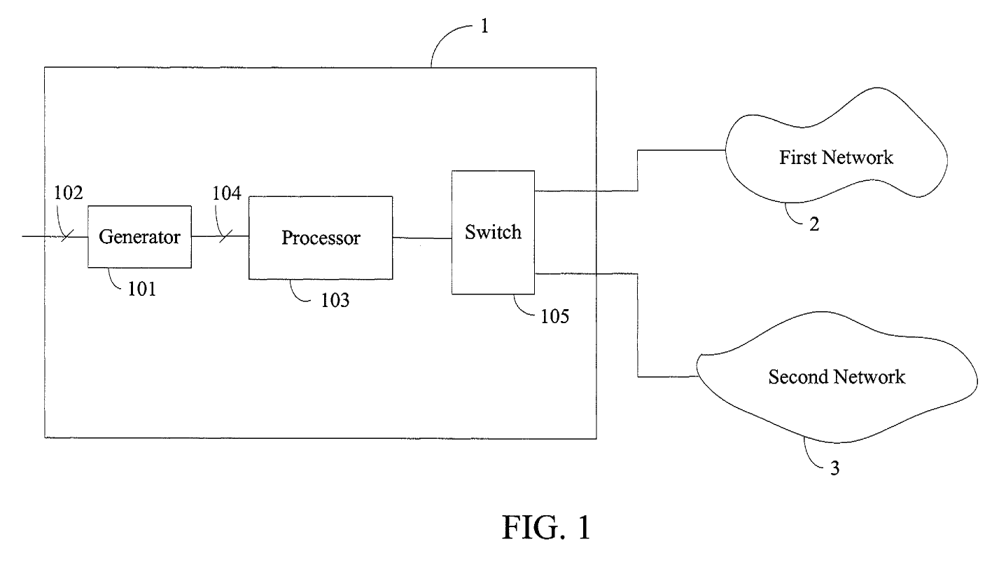

A first embodiment of the present invention is a communication system as FIG. 1 shows. The communication system comprises an apparatus 1, a first network 2, and a second network 3. In this embodiment, the first network 2 is Internet and the second network 3 is a telenetwork. The apparatus 1, connected to the first network 2 and the second network 3, is a telephone, a mobile phone, a PDA, or any communication product that can access Internet and the telenetwork.

The apparatus 1 comprises a generator 101, a processor 103, and a switch 105. The generator 101 receives user's inputs 102 associated with first connection information of a person through the first network 2 and second connection information of the same person through the second network 3. The generator 101 generates a table which stores the first connection information and the second connection information. In this embodiment, the first connection information is an online communication service of the person, such as a Skype account, an MSN messenger account or a Yahoo messenger account, and the second connection information is a phone number of the person. When the user would like to reach the person, the processor 103 retrieves a data 104 comprising the first connection information and the second connection information from the table. Since the first network 2 is more economical, the switch 105 initially selects the first network 2 to communicate first. The processor 103 checks the status of the first network 2 at calling. More specifically, the processor 103 checks whether Internet is active and the person has logged in one of the online communication services. If the online communication service, such as MSN messenger or Yahoo messenger, requires a server to communicate, the processor 103 checks the status of the first network 2 by polling a server. If the online communication service, such as Skype, utilizes peer-to-peer (P2P) communication, the processor 103 checks the status of the first network 2 by polling a peer.

Considering that the first connection information is a Skype account, Skype uses an application program interface (API) called ONLINESTATUS to detect whether the person connects to Internet or not. The statuses of the Skype account of the person have so-called UNKNOWN, OFFLINE, ONLINE, AWAY, NA, and DND. The UNKNOWN status means that the person is an unknown user. The OFFLINE status means that the person does not log in. The ONLINE status means that the person is on line and available. The AWAY status means that the person is on line but temporarily not available. The NA status means that the person is not available. The DND status means that the person is in a “Do not disturb” mode. In this embodiment, the processor 103 treats that the first network is available when the ONLINE status is detected.

If the ONLINE status is detected, the apparatus 1 will reach the person through the first network 2 in response to the first connection information. If one of the other statuses is, however, detected, the switch 105 selects the second network 3 to communicate with the person in response to the second connection information. After the communication is built, the communication is capable of transmitting various types of data, such as texture data, audio data, video data, or multimedia data.

Rather than checking the status at calling, the processor 103 may check the status periodically when the apparatus 1 is connected to the first network 2.

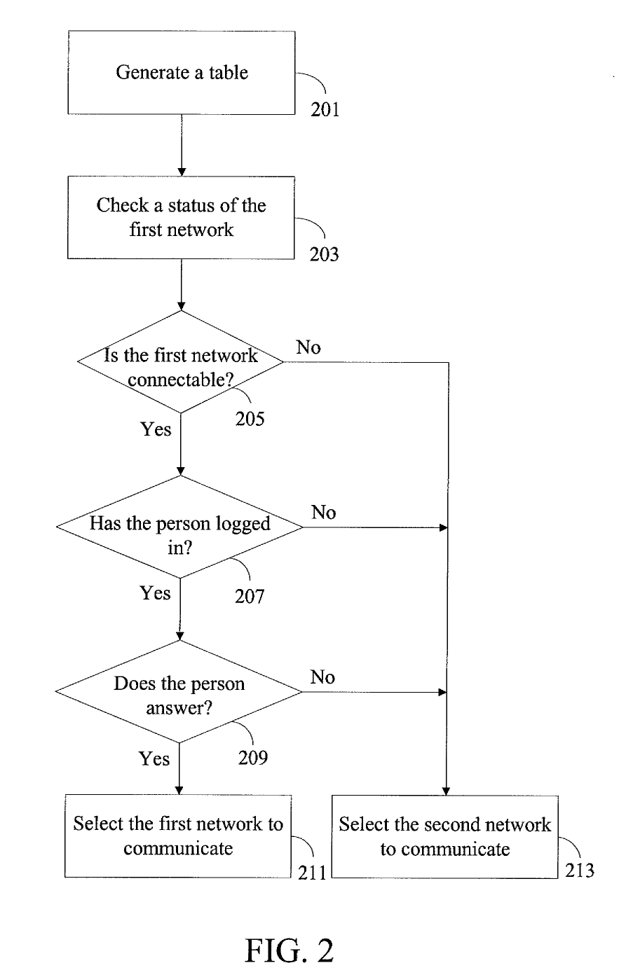

A second embodiment of the present invention is a method for switching between a first network and a second network. The second embodiment corresponds to the first embodiment. In particular, the second embodiment may be performed by a system like the first embodiment. As shown in FIG. 2, the second embodiment comprises the following steps. In step 201, a generator, such as the generator 101, generates a table, wherein the table stores first connection information for the first network and second connection information for the second network. Then step 203 is executed in which a processor, such as the processor 103, checks a status of the first network in response to the first connection information. In step 205, the processor determines whether the first network is connectable. If no, step 213 is executed, wherein a switch, such as the switch 105, selects the second network to communicate in response to the second connection information. If yes, step 207 is executed to determine whether the person has logged in. If no, step 213 is executed. If yes, step 209 is executed to try to reach the person and to determine whether the person answers. If no, step 213 is executed. If yes, step 211 is executed in which the switch 105 maintains the first network to communicate.

Similarly, step 205 may be executed periodically or at calling. The processor is able to check the status of the first network by either polling a server or polling a peer. In addition to the steps shown in FIG. 2, the second embodiment may perform all of the operations and functions recited in the first embodiment.

Accordingly, the present invention is capable of checking the status of the first network automatically and switching to the second network to communicate if the first network is not available. By switching between the networks automatically, the user may reach the person through more than one way.

Although the above embodiments take two networks as an example, those skilled in the art can easily understand that switching between two networks is just for sake of simplicity. In other words, the present invention may also switch among more than two networks.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. An apparatus for switching between a first network and a second network, comprising:
a generator for generating a table, the table storing first connection information for the first network and second connection information for the second network;
a processor for checking a status of the first network in response to the first connection information; and
a switch for selecting the second network to communicate in response to the second connection information if the status indicates that the first network is not available.

2. The apparatus as claimed in claim 1, wherein the processor checks the status periodically.

3. The apparatus as claimed in claim 1, wherein the processor checks the status at calling.

4. The apparatus as claimed in claim 1, wherein the processor checks the status by polling a server.

5. The apparatus as claimed in claim 1, wherein the processor checks the status by polling a peer.

6. The apparatus as claimed in claim 1, wherein the first network is Internet.

7. The apparatus as claimed in claim 6, wherein the second network is a telenetwork.

8. The apparatus as claimed in claim 1, wherein the communication transmits audio data.

9. The apparatus as claimed in claim 1, wherein the communication transmits audio and video data.

10. The apparatus as claimed in claim 1, wherein the communication transmits texture data.

11. A method for switching between a first network and a second network, comprising the steps of:
generating a table, the table storing first connection information for the first network and second connection information for the second network;
checking a status of the first network in response to the first connection information; and
selecting the second network to communicate in response to the second connection information if the status indicates that the first network is not available.

12. The method as claimed in claim 11, wherein the checking step is executed periodically.

13. The method as claimed in claim 11, wherein the checking step is executed at calling.

14. The method as claimed in claim 11, wherein the checking step comprises a step of polling a server.

15. The method as claimed in claim 11, wherein the checking step comprises a step of polling a peer.

16. The method as claimed in claim 11, wherein the first network is Internet.

17. The method as claimed in claim 16, wherein the second network is a telenetwork.

18. The method as claimed in claim 11, wherein the communication transmits audio data.

19. The method as claimed in claim 11, wherein the communication transmits audio and video data.

20. The method as claimed in claim 11, wherein the communication transmits texture data.

21. A communication system, comprising:
a first network;
a second network; and
an apparatus having a table, the table storing first connection information for the first network and second connection information for the second network;
wherein the apparatus checks a status of the first network in response to the first connection information, and selects the second network to communicate in response to the second connection information if the status indicates that the first network is not available.

22. An apparatus for connecting a first network and a second network, comprising:
means for generating a table, the table storing first connection information for the first network and second connection information for the second network;
means for checking a status of the first network in response to the first connection information; and
means for selecting the second network to communicate in response to the second connection information if the status indicates that the first network is not available.
